(19) United States
(12) Patent Application Publication
(10) Pub. No.: US 2017/0113797 A1
(43) Pub. Date: Apr. 27, 2017

(54) Convertible Aircraft

(71) Applicant: Allison Aviation Corp., Brookfield, WI (US)

(72) Inventor: Richard Hogan, Woodstock, GA (US)

(21) Appl. No.: 15/209,007

(22) Filed: Jul. 13, 2016

Related U.S. Application Data
(60) Provisional application No. 62/194,494, filed on Jul. 20, 2015.

(51) Int. Cl. B64C 37/00; B64C 25/34; B64C 25/14; B60F 5/02; B64C 3/56

(52) U.S. Cl. CPC B64C 37/00; B60F 5/02; B64C 3/56; B64C 25/14; B64C 25/34

(57) ABSTRACT

An aircraft includes a fuselage, a pair of wings and landing gear which is movable between two operative positions. In a first position of the landing gear, the center of gravity of the aircraft is in a rearward, elevated position and in a second position of the landing gear, the center of gravity of the aircraft is in a forward, lowered position. The landing gear includes a front section and a rear section. The rear section is pivotably mounted to the fuselage for movement between a lowered, forward position when the landing gear is in the first position and a raised. rearward position when the landing gear is in the second position. The front section of the landing gear is axially extendible between a lowered position when the landing gear is in the first position and a raised position when the landing gear is in the second position.

### CROSS-REFERENCE TO RELATED APPLICATION

This application claims the benefit of U.S. Ser. No. 62/194,494 filed Jul. 20, 2015, the disclosure of which is incorporated herein in its entirety.

### BACKGROUND OF THE INVENTION

1. Field of the Invention

The present invention relates in general to aircraft, and more particularly to an airplane type of aircraft that can be converted from a flight configuration to a roadable or driving configuration.

2. Background

Many attempts have been made to develop an aircraft that can be flown in the same manner as a relatively conventional small aircraft and that can also be driven on roads. Such previous attempts have a number of drawbacks. For example, use of an automobile-type suspension in such an aircraft makes the takeoff and landing angle very flat, which requires a long runway and advanced pilot skills. Some attempts have required complex adjustments and operations when converting from a road configuration to a flight configuration. Often, designs have been quite heavy thus also contributing to the need for a long runway and reducing performance at all levels. These are but some of the numerous drawbacks of designs that have been attempted in the past.

### BRIEF DESCRIPTION OF THE INVENTION

By way of summary, the present invention relates to a convertible or roadable aircraft that includes unique features that enable it to perform extremely well in both a flight configuration and a road configuration.

In accordance with one aspect of the invention, a convertible or roadable aircraft includes landing gear that can be positioned in either a flight position or a road position. In one form, the landing gear includes a front component, such as a nose wheel, and a rear component such as a pair of main wheels. The landing gear may either be retractable or non-retractable. The flight position of the landing gear provides advantages for takeoff and landing, and the road position provides advantages in enabling the aircraft to be driven on roads. In the flight position, the landing gear functions to place the center of gravity of the aircraft relatively closer to the rear, to facilitate takeoff and landing. In the road position, the landing gear functions to place the center of gravity of the aircraft forwardly relative to its location when the landing gear is in the flight position. In addition, in the road position, the landing gear functions to lower the center of gravity to facilitate handling as well as to accommodate height restrictions associated with operation on roads.

The convertible or roadable aircraft also includes a wing folding arrangement. in this regard, a joint is provided between the fuselage and an inner end of each wing. A folding mechanism is provided at the joint, and is configured to place each wing in a generally horizontal orientation when the aircraft is in a flight configuration. When it is desired to operate the aircraft on roads, each folding mechanism is operated so as to place its associated wing in a folded position over the fuselage. The wings and folding mechanisms are configured such that, when the aircraft is in a road configuration, the wings are in an overlapping relationship.

The positionable landing gear and the folding wing arrangement of the aircraft make the aircraft particularly well suited for both driving on roads and conventional flight while eliminating many drawbacks associated with previous designs.

These and other features and aspects of the present invention will be better appreciated and understood when considered in conjunction with the following description and the accompanying drawings It should be understood, however, that the following description, while indicating a representative embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a top plan view of a convertible or roadable aircraft in accordance with the present invention, showing the aircraft in a flight configuration;

FIG. 2 is a side elevation view of the aircraft of FIG. 1 in the flight configuration;

FIG. 3 is a front elevation view of the aircraft of FIG. 1 in the flight configuration;

FIG. 4 is a top plan view of the aircraft of FIG. 1, showing the aircraft in a road configuration;

FIG. 5 is a side elevation view of the aircraft of FIG. 1 in the road configuration;

FIG. 6 is a front elevation view of the aircraft of FIG. 1 in the road configuration;

FIG. 7 is an enlarged side elevation view of the aircraft of FIG. 1 in the flight configuration;

FIG. 8 is an enlarged side elevation view of the aircraft of FIG. 1 in the road configuration;

FIG. 9 is an isometric view of the aircraft of FIG. 1, with portions shown transparently so as to illustrate the landing gear;

FIG. 10 is a side elevation view of the aircraft of FIG. 1, showing the landing gear in the road position;

FIG. 11 is a rear isometric view of the aircraft of FIG. 1 showing the landing gear in the road position;

FIG. 12 is an enlarged view similar to FIG. 11;

FIG. 13 is an isometric view of the nose gear alone;

FIG. 14 is a side elevation view similar to FIG. 10, showing the landing gear in the flight position;

FIG. 15 is an isometric view illustrating the components of the landing gear isolated from the aircraft;

FIG. 16 is a partial isometric view illustrating the front portion of the aircraft and the nose gear.

FIG. 17 is a partial side elevation view showing the nose gear in the extended and retracted positions;

FIG. 18a is an isometric view illustrating the folding mechanism Incorporated into the wings of the aircraft of FIG. 1 for use in moving the wings between an extended position for placing the aircraft in the flight configuration and a folded position for placing the aircraft and the road configuration, and showing the folding mechanism in an open position for placing the wing in the extended position;

FIG. 18b is in end isometric view of the folding mechanism in the open position;

FIG. 18c is a side isometric view of the folding mechanism, showing movement of the folding mechanism away from the open position and toward a folded position;

FIG. 18d is an end isometric view of the folding mechanism during movement toward the folded position;

FIG. 18e is a bottom isometric view of the folding mechanism during movement toward the folded position;

FIG. 18f is an enlarged top isometric view of the folding mechanism during movement toward the folded position;

FIG. 18g is a bottom isometric view of folding mechanism during movement toward the folded position; and

FIG. 18h is a bottom isometric view similar to FIG. 18g of the folding mechanism during movement toward the folded position of.

In describing the embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiment described in detail in the following description.

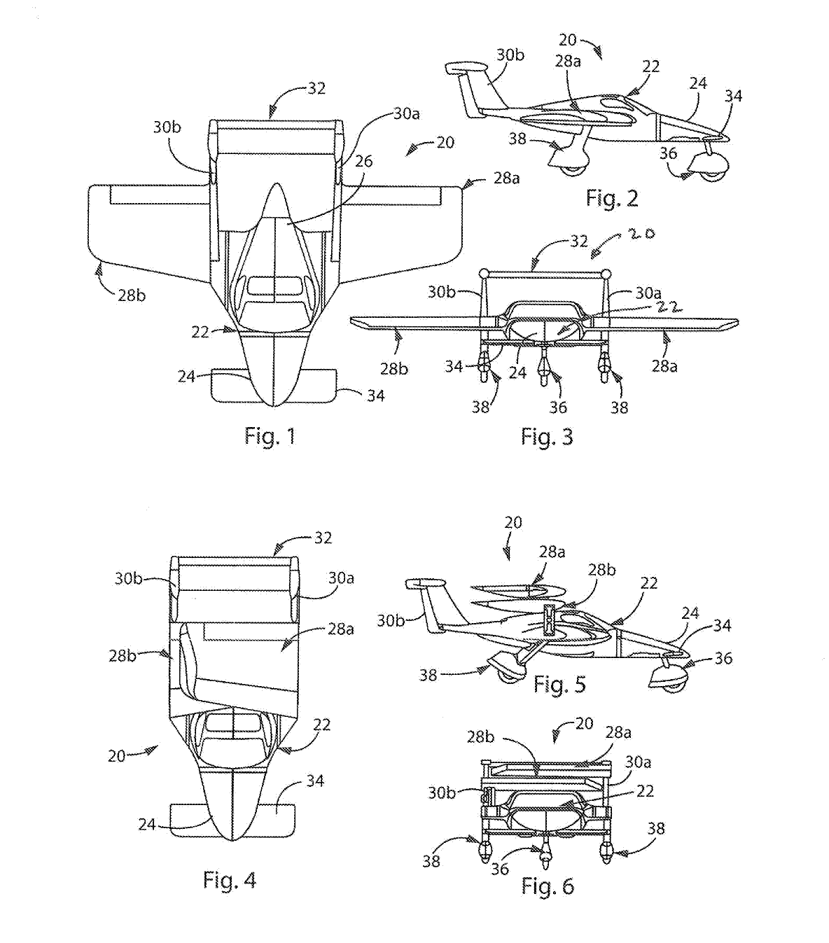

As shown in FIGS. 1-6, a convertible or roadable aircraft, shown generally at 20, generally includes a fuselage 22 defining a nose 24 and a tail 26, in combination with a pair of wings shown generally at 28a, 28b. The aircraft 20 is configured such that the majority of fuselage 22 is located forwardly of the wings 28a, 28b. The aircraft 20 further includes a pair of tailfins 30a, 30b that extend rearwardly from the sides of fuselage 22. An upper rear wing 32 extends between and connects the tailfins 30a, 30b. A propeller (not shown in FIGS. 1-6) is rotatably mounted to the rear of aircraft tail 26 between the tailfins 30a, 30 and generally below upper rear wing 32. In addition, aircraft 20 includes a canard 34 below nose 24.

Aircraft 20 also includes landing gear in the form of nose landing gear shown generally at 36 and main landing gear shown generally at 38. Nose landing gear 36 is located below nose 24 of fuselage 22 and below canard 34. Main landing gear 38 is located slightly rearwardly of the cabin of fuselage 22. It is understood, however, that the precise locations of nose landing gear 36 and main landing gear 38 may vary. It is also understood that, while a single nose landing gear 36 is illustrated, an additional nose landing gear 36 may be employed to provide a four-point landing and takeoff system.

Still referring to FIGS. 1-6, the aircraft 20 is convertible between a flight configuration as shown in FIGS. 1-3 and a road configuration as shown in FIGS. 4-6. In a mariner to be explained, the landing gear of aircraft 20 can be moved between a flight position as shown in FIGS. 1-3 and a road position as shown in FIGS. 4-6. In addition, as will also be explained, the wings 28a, 28b can be placed in a flight position as shown in FIGS. 1-3 and a road position as shown in FIGS. 4-6. Generally, the flight position of landing gear 36, 38 facilitates takeoff and landing of aircraft 20 while the road position of landing gear 36, 38 facilitates operation of aircraft 20 as an on-road vehicle. When in the flight position, landing gear 36, 38 position the center of gravity of aircraft 20 relatively upwardly and forwardly to facilitate takeoff and landing, whereas in the road position landing gear 36, 38 position the center of gravity of aircraft 20 relatively downwardly and rearwardly to facilitate on-road movement and handling. The flight position of wings 28a, 28b provides operation of aircraft 20 as an airplane while the road position of wings 28a, 28b enables aircraft 20 to meet requirements for use of aircraft 20 as an on-road vehicle. The wings 28a, 28b are fully extended when in the flight position, and in the road position are folded over the fuselage 22 so that the wings 28a, 28b overlap each other.

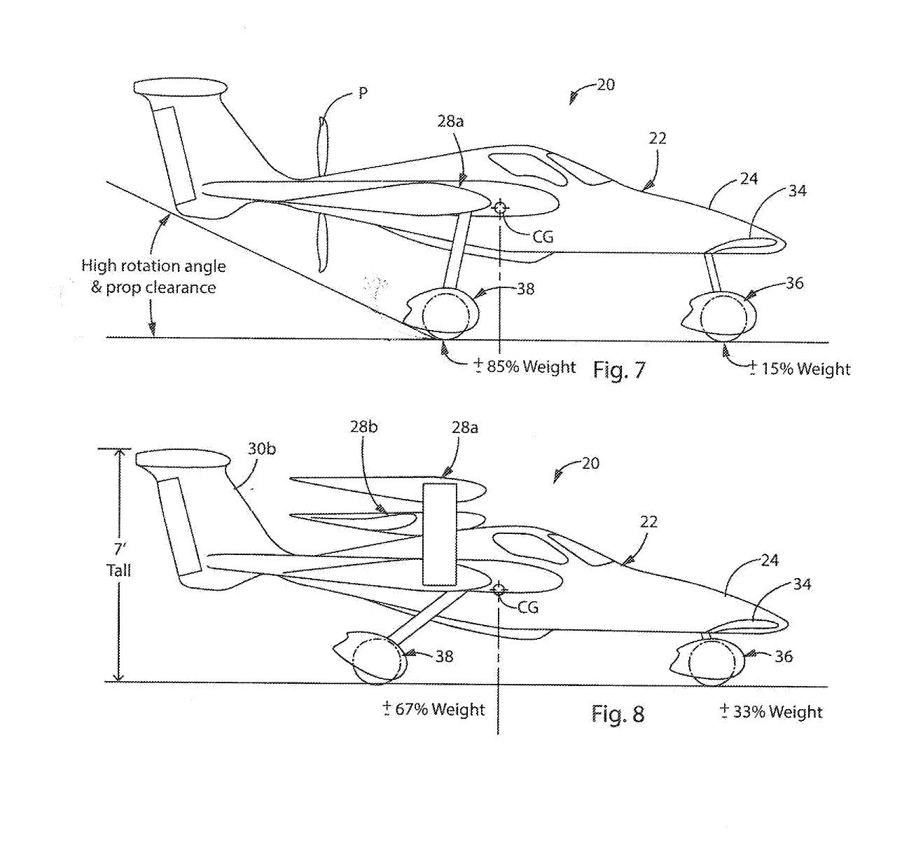

FIG. 7 illustrates aircraft 20 in the flight configuration and FIG. 8 illustrates aircraft 20 in the road configuration. FIG. 7 also illustrates a propeller P that is rotatably mounted to the tail 26 of fuselage 22. The propeller P is driven by a fuel-powered aircraft motor for use of aircraft 20 when flying. Aircraft 20 is provided with any satisfactory motive means for road use, such as an electrically-powered drive arrangement.

In the flight configuration of aircraft 20 as shown in FIG. 7, the wings 28a, 28b are in the flight position in which wings 28a, 28b are extended or unfolded, in generally a horizontal configuration as is required for flight. The landing gear 36, 38 is also in the flight position, in which nose landing gear 36 is extended and main landing gear 38 is in a forward, generally upright orientation. In the road configuration of aircraft 20 as shown in FIG. 8, the wings 28a, 28b are in the road position in which wings 28a, 28b are folded to an overlapping relationship above fuselage 22. The landing gear 36, 38 is also in the road position, in which nose landing gear 36 is retracted and main landing gear 38 is in a rearward and raised position. FIGS. 7 and 8 illustrate the position of the center of gravity of aircraft 20 in the flight and road configurations, respectively. As shown in FIG. 7, the center of gravity of aircraft 20 in the flight configuration is relatively close to main landing gear 38 such that main landing gear 38 carries a significant portion of the weight of aircraft 20. Representatively, as shown in FIG. 7. when aircraft 20 is in the flight configuration main landing gear 38 carries approximately 85% of the weight of aircraft 20 and nose landing gear 36 carries approximate 15% of the weight of aircraft 20. When aircraft 20 is in the road configuration as shown in FIG. 8, the nose landing gear 36 is retracted relative to its position when aircraft 20 is in the flight configuration, and main landing gear 38 is pivoted about an upper pivot axis upwardly and rearwardly relative to its position when aircraft 20 is in the flight configuration. These alterations in the positions of nose landing gear 36 and main landing gear 38 function to position the center of gravity of aircraft 20 lower than in the flight configuration and significantly forwardly of main landing gear 38 closer to nose landing gear 36 compared to the position of the center of gravity of aircraft 20 when in the flight configuration. Representatively, as shown in FIG. 8, when aircraft 20 is in the road configuration main landing gear 38 carries approximately 67% of the weight of aircraft 20 and nose landing gear 36 carries approximately 33% of the weight of aircraft 20. It is understood that the weight percentages as set forth above are illustrative of the weight distribution differences that exist between the flight and road configurations, and that other relative percentages are contemplated as being within the scope of the present invention.

It is also understood that, while nose landing gear 36 is shown as being extendable and retractable, it may also be movable about a pivot axis in the same manner as main landing gear 38 so that it can be positioned more forwardly and upwardly when in the road configuration as compared to the primarily upward movement as illustrated in which nose landing gear 36 is simply extended and retracted between positions.

The articulating landing gear 36, 38 as described optimizes ground handling, and takeoff and landing characteristics, of aircraft 20. The placement of the significant majority of the weight of aircraft 20 on main landing gear 38 when in the flight position allows for proper rotation of aircraft 20 and takeoff. The elevation of aircraft 20 provided by landing gear 36, 38 in flight configuration is adequate for proper clearance of propeller P, and also provides required wingtip height for crosswind operations. When the landing gear 36, 38 is placed in the road position so that additional weight is placed on nose gear 36, the resulting vehicle is less prone to tip even under aggressive braking or crosswind conditions. The vehicle is also lowered for clearance limitations and easy entry/egress. In addition, when the landing gear 36, 38 is placed in the road position, the propeller P is locked in a horizontal position to provide ground clearance.

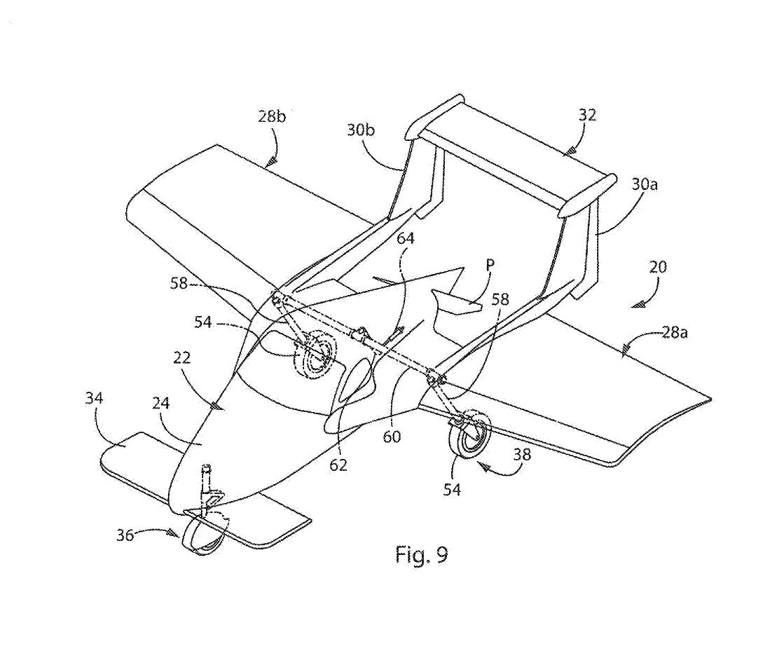

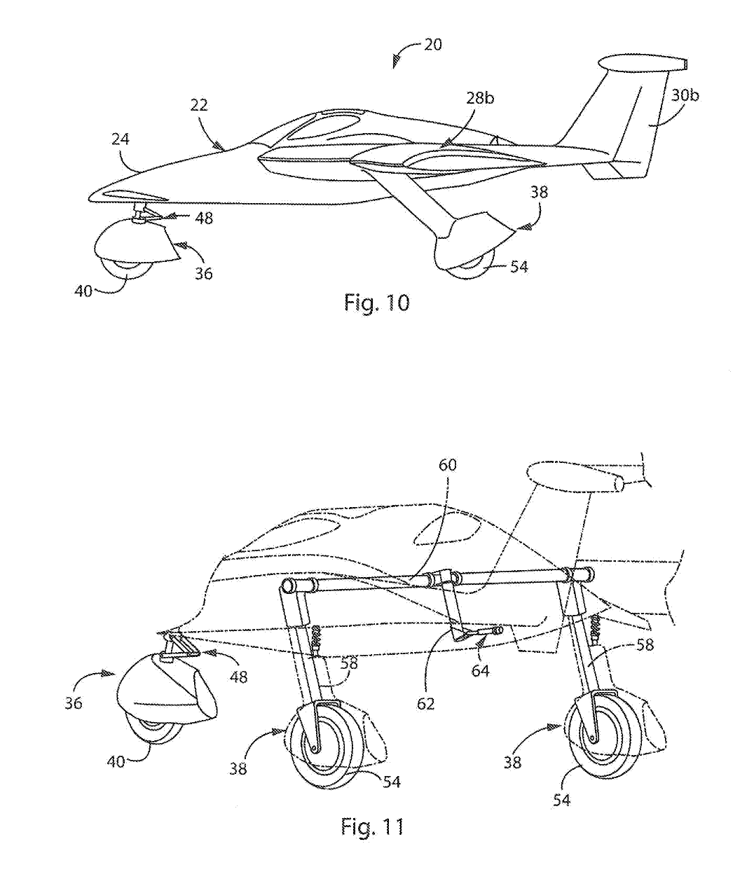

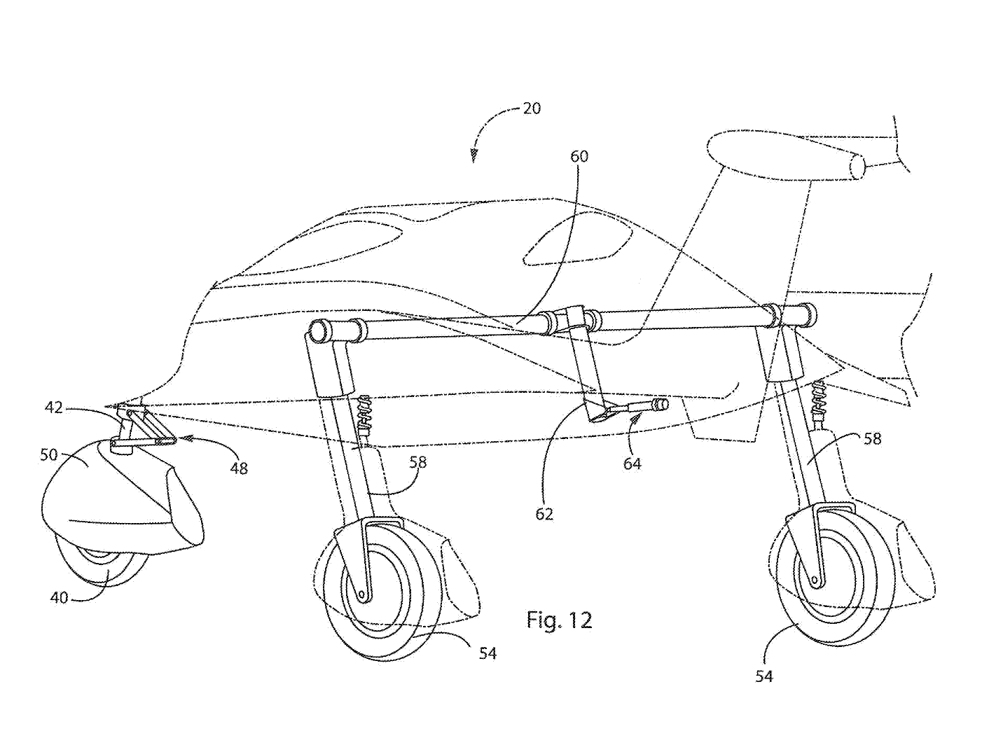

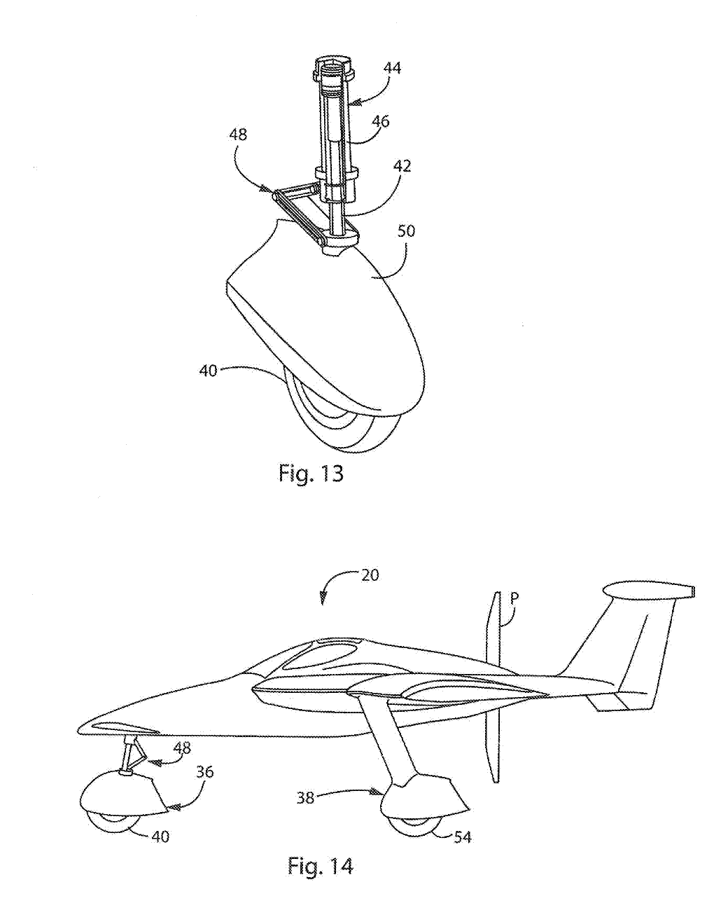

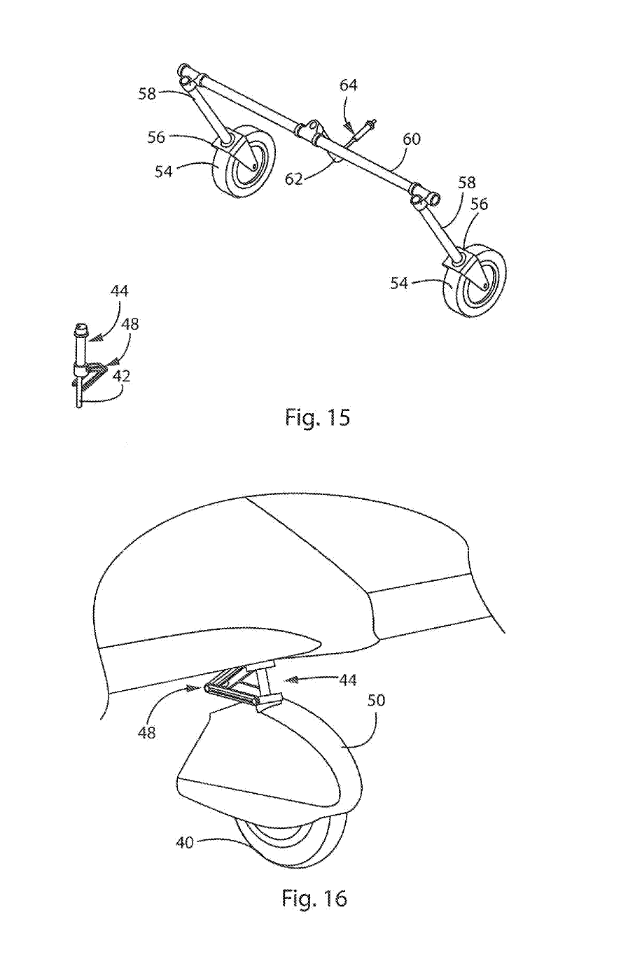

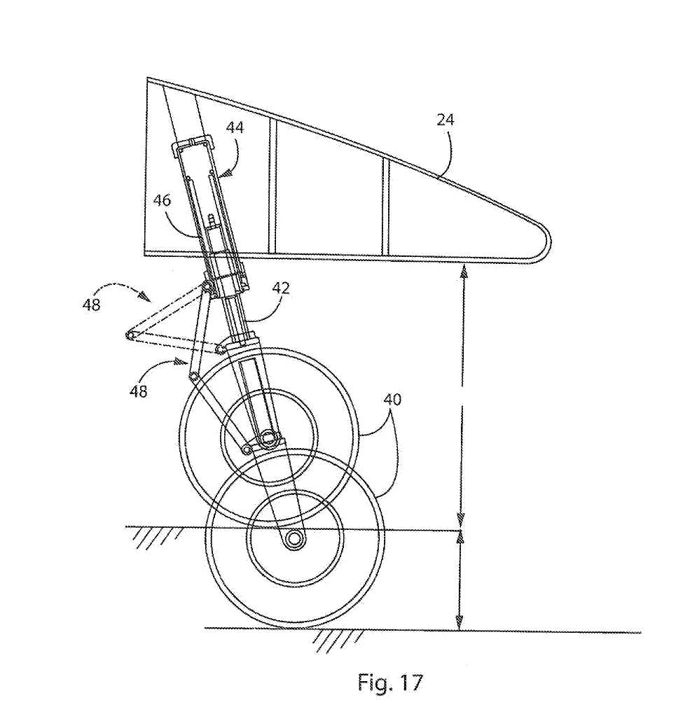

FIGS. 9-17 illustrate details of landing gear 36, 38.

Nose landing gear 36 includes a front wheel 40 rotatably mounted to an axle secured to the end of an extendable and retractable rod 42, such as via a suitable bracket or the like. Representatively, the rod 42 may be part of a hydraulic cylinder assembly 44 that is secured to nose 24 of aircraft 20. In a manner as is known, the inner end of rod 42 is interconnected with a piston such that introduction or removal of hydraulic fluid to or from a cylinder 46 of hydraulic cylinder assembly 44 causes extension and retraction of rod 42. A linkage assembly 48 is secured to cylinder assembly 44 and to a shroud 50 and the axle wheel 40 for structural support and to accommodate extension and retraction of rod 42.

Main landing gear 38 includes a pair of wheels 54 rotatably mounted to axles and brackets 56, each of which in turn is secured to the lower end of a strut 58. The upper ends of struts 58 are non-rotatably fixed to a cross-shaft 60, which functions as a torsion bar during road operation. An actuating arm 62 is non-rotatably fixed to cross-shaft 60, and an actuator 64 is engaged with the outer end of actuating arm 62. Representatively, actuator 64 may be in the form of a screw-type linear actuator, although it is understood that any other type of linear movement mechanism may be employed. With this arrangement, extension and retraction of actuator 64 is transferred through actuating arm 62 to impart rotation to cross-shaft 60, which in turn functions to pivot struts 58 about a pivot axis defined by cross-shaft 60 for providing movement of main landing gear 38 between the flight and road positions.

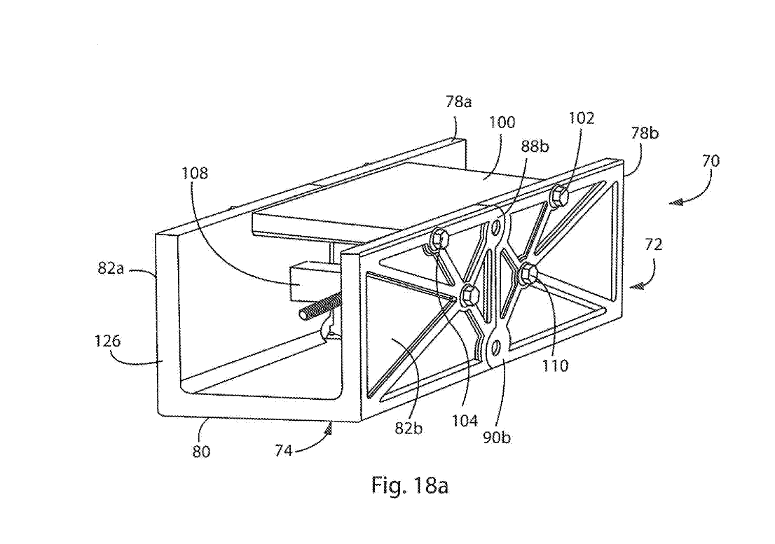

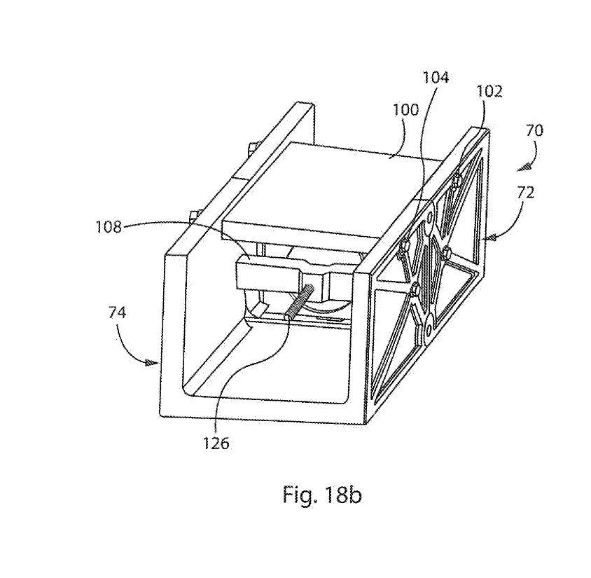

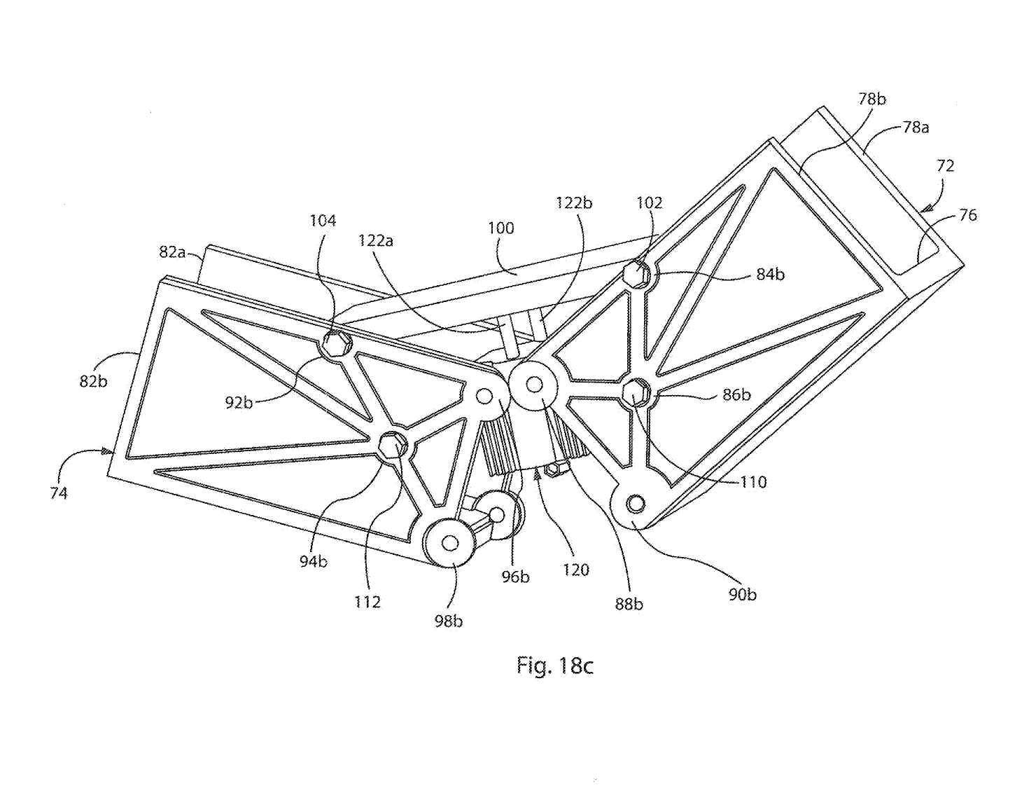

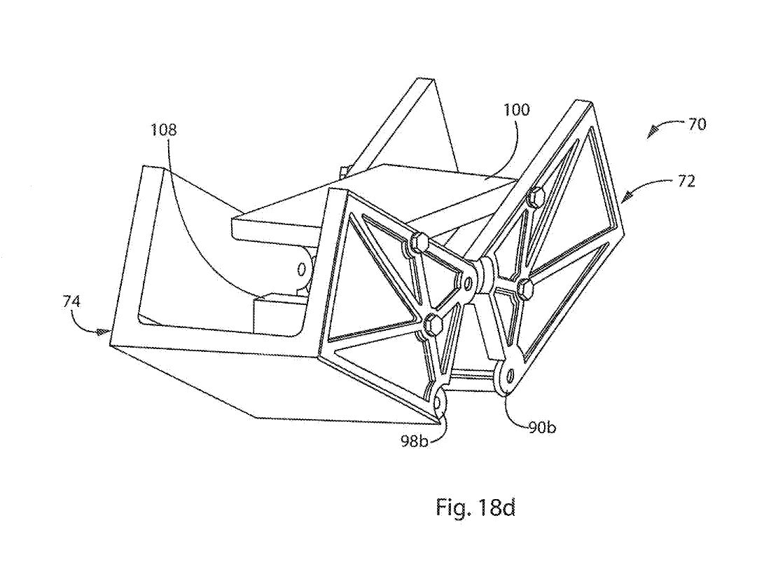

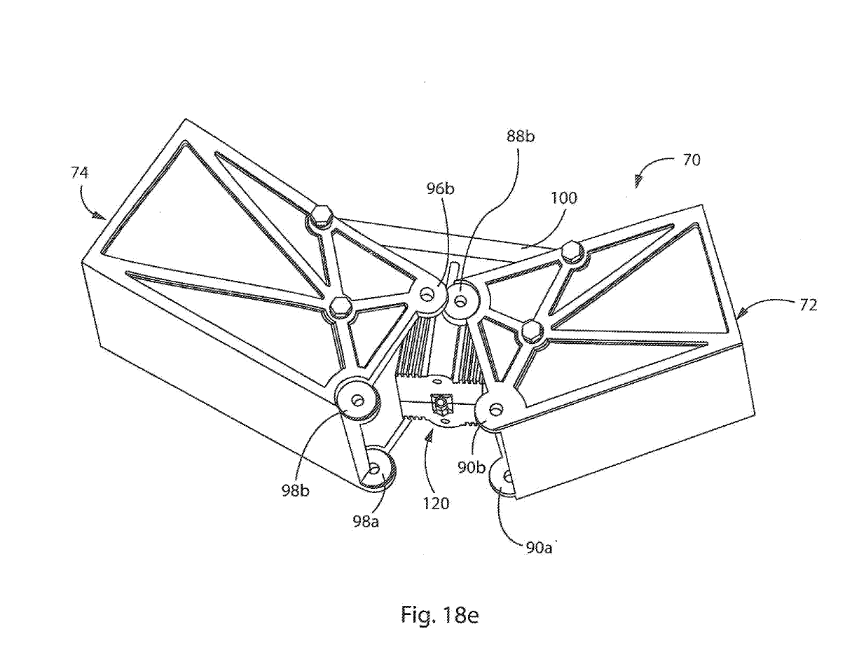

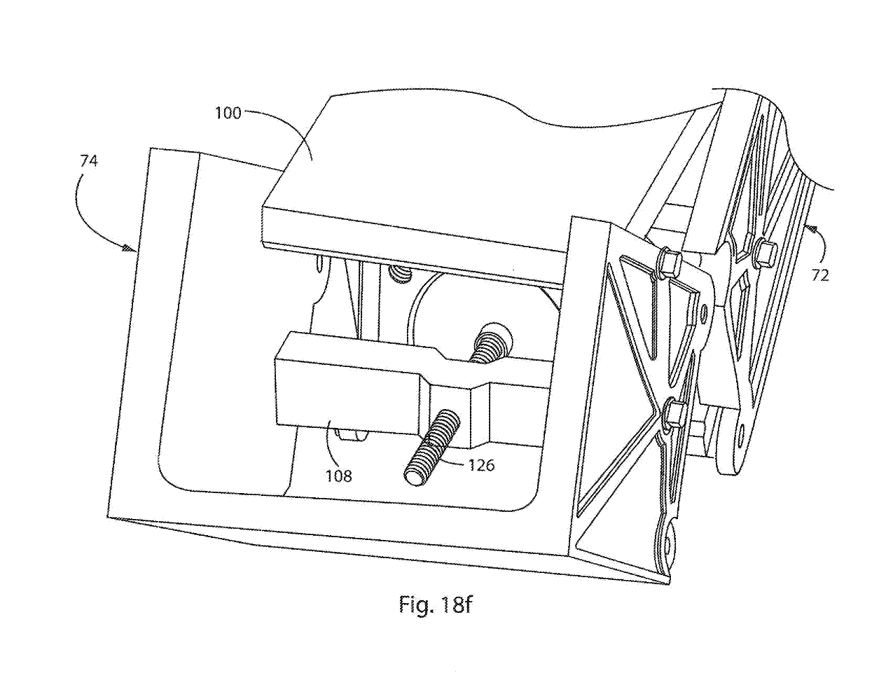

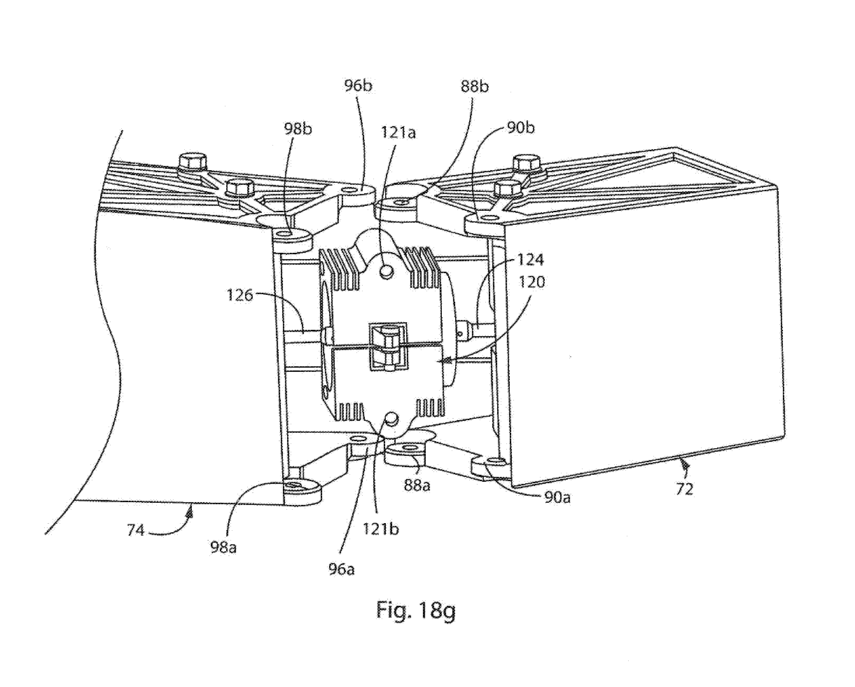

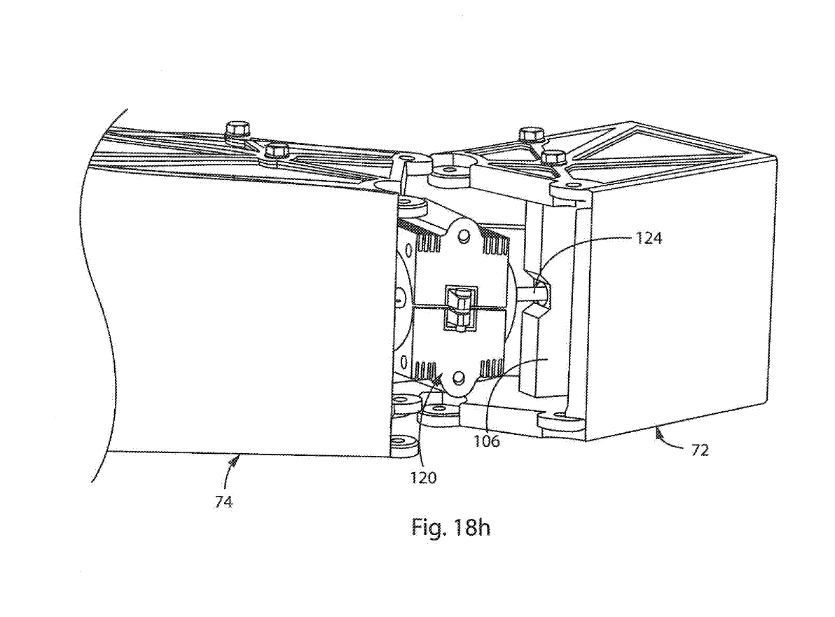

FIGS. 18a-18h illustrate a folding mechanism 70 and that is employed for moving wings 28a, 28b between the flight and road positions. The folding mechanism 70 is shown separated from the aircraft 20. Generally, the folding mechanism 70 includes a pair of U-shaped structural members 72, 74, one of which is integrated into the structure of the frame of fuselage 22 and the other of which is integrated into the structure of the frame of wing such as 28a, 28b. While U-shaped structural members 72, 74 are illustrated, it is understood that the structural members 72, 74 may have any other configuration as desired.

In the illustrated embodiment, structural member 72 has a generally channel configuration defining a bottom wall 76 and a pair of sidewalls 78a, 78b. Similarly, structural member 74 has a generally channel configuration defining a bottom wall 80 and a pair of sidewalls 82a, 82b. The sidewalls 78a, 78b and 82a, 82b may include reinforcing ribs for strength. The sidewalls 78a, 78b of structural member 72 include pivot joint bosses such as shown at 84b, 86b, as well as a pair of connection bosses such as shown at 88b, 90b. Similarly, the sidewalls 82a, 82b of structural member 74 include pivot joint bosses such as shown at 92b, 94b, as well as a pair of connection bosses such as shown at 96b, 98b.

An actuating link or plate 100 extends between and movably interconnects structural members 72, 74. Actuating plate 100 has a width that enables it to fit between sidewalls 78a, 78b of structural member 72 and between sidewalls 82a, 82b of structural member 74. Each end of actuating plate 100 is provided with a transverse passage, with the transverse passage at one end being aligned with an opening in pivot joint boss 84b of sidewall 78b and an opening in a similar pivot joint boss of sidewall 78a. A transverse pivot shaft extends through the aligned openings and passages. The pivot shaft may be in the form of a bolt having a head such as 102 at one end and threads at the opposite end in a manner as is known, with which a nut is engageable so as to secure the pivot shaft in position. Similarly, the transverse passage at the opposite end of actuating plate 11 is aligned with an opening in pivot joint boss 92b of sidewall 82b and an opening in a similar pivot joint boss of sidewall 82a. A transverse pivot shaft extends through the aligned openings and passages. The pivot shaft may be in the form of a bolt having a head such as 104 at one end and threads at the opposite end in a manner as is known, with which a nut is engageable so as to secure the pivot shaft in position. Alternatively, instead of a single transverse pivot shaft at each end of actuating plate 100, a pair of stub-type pivot shafts may be employed, each of which extends into an aligned pivot passage in actuating plate 100. The pivot shafts may have heads and threads that engage threads in the openings in the pivot bosses, such as 84b, and unthreaded ends that extend into the actuating plate pivot passages.

In addition, a transverse yoke 106 is positioned between sidewalls 87a, 78b of structural member 72 and a transverse yoke 108 is positioned between the sidewalls 82a, 82b of structural member 74. Each yoke 106, 108 defines a pair of opposite ends, and a pivot passage extends inwardly from each end of each yoke 106, 108. Yoke 106 is pivotably mounted between structural member sidewalls 78a, 78b via a pair of pivot shafts, each of which extends through an opening in one of the pivot bosses, such as 86b, and into the yoke pivot passage that is aligned therewith. The pivot shafts may have heads such as shown at 110 and threads that engage threads in the openings in the pivot bosses, such as 86b, and unthreaded ends that extend into the yoke pivot passages. Similarly, yoke 108 is pivotably mounted between structural member sidewalls 82a, 82b via a pair of pivot shafts, each of which extends through an opening in one of the pivot bosses, such as 94b, and into the yoke pivot passage that is aligned therewith. The pivot shafts may have heads such as shown at 112 and threads that engage threads in the openings in the pivot bosses, such as 94b, and unthreaded ends that extend into the yoke pivot passages.

An actuating motor 120 is positioned between structural members 72, 74 below actuating plate 100. Actuating motor 120 may be any satisfactory type of motor as is known, and representatively may be a hydraulic or electric motor. The housing of motor 120 includes a pair of spaced-apart guide passages 121a, 121b. A pair of guide rods 122a, 122b are secured at one end to the underside of actuating plate 100 and extend into, and are axially movable within, the guide passages 121a, 121b of the housing of motor 120.

Actuating motor 120 drives rotation of a pair of axially aligned actuating screws 124, 126. Actuating screws 124, 126 may be integrally formed and opposite ends of a unitary screw, or alternatively may be separate screw sections. Actuating screw 124 is threadedly engaged with a threaded passage in the central area of yoke 106, and actuating screw 126 is threadedly engaged with a threaded passage in the central area of yoke 108. Actuating screws 124, 126 extend along an axis perpendicular to the longitudinal axes of yokes 106, 108. The threads of actuating screws 124, 126 and the threaded passages of yokes 106, 108, respectively, are configured such that rotation of screws 124, 126 in a first direction by operation of motor 120 functions to move yokes 106, 108 away from each other, and rotation of screws 124, 126 in a second direction opposite the first direction by operation of motor 120 functions to move yokes 106, 108 toward each other.

In operation, wing folding mechanism 70 functions as follows. When wings 28a, 28b are extended to place aircraft 20 in the flight configuration, folding mechanism 70 is positioned as shown in FIG. 18a. In this position, the connection bosses of structural members 72, 74 are in overlapping relationship with each other and the openings in the connection bosses are aligned with each other. Specifically, an opening in connection boss 88b of structural member 72 is aligned with an opening in connection boss 96b of structural member 74, and an opening in connection boss 90b of structural member 72 is aligned with an opening in connection boss 98b of structural member 74. The same occurs with respect to openings in connection bosses 88a, 96a and openings in connection bosses 90a, 98a. Retainer pins (not shown) are inserted into the aligned openings in the connection bosses so as to maintain each wing in the extended position.

When it is desired to place aircraft 20 in the road configuration, the retainer pins are removed and motor 120 is operated so as to impart rotation to actuating screws 124, 126. As noted previously, this functions to move yokes 106, 106 away from each other. During such movement of yokes 106, 106, the ends of structural members 72, 74 are moved apart. The pivot shafts engaged with the ends of actuating plate 100 define pivot points at the upper ends of the structural members 72, 74, and the pivot connections with the ends of yokes 106, 108 define pivot points at an intermediate location below the actuating plate pivot points. This compound or “double knuckle” action functions to elevate the inner end of the wing to a position at which the wing is located above the fuselage 22, and at the same time pivot the wing to a position over the top of fuselage 22. A suitable retainer arrangement may be employed to maintain the wings 28a, 28b in the folded position, such as engagement of the wings 28a, 28b with each other or with one or more anchors on the fuselage 22. The above steps are then reversed in order to return the wings 28a, 28b to the extended or unfolded position.

To provide the overlapping feature of wings 28a, 28b as described above, the placement of the pivots for the actuating plate 100 is farther apart on the wing that overlaps and the yoke and screw drive is also longer. Operation, however, is the same as described above.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. An aircraft, comprising a fuselage, a pair of wings and landing gear, wherein the wings are movable between an operative position in which the wings extend outwardly from the fuselage and an inoperative position in which the wings are in a folded position and at least a portion of each wing is located above the fuselage.

2. The aircraft of claim 1, wherein when the wings are in the inoperative position the portions of the wings located above the fuselage vertically overlap each other.

3. An aircraft, comprising a fuselage, a pair of wings and landing gear, wherein the landing gear is movable between at least two different operative positions, wherein in a first operating position of the landing gear the center of gravity of the aircraft is in a first relatively rearward and elevated position and in a second operating position of the landing gear the center of gravity of the aircraft is in a second relatively forward and lowered position.

4. The aircraft of claim 3 wherein the landing gear includes a front section and a rear section, wherein at least the rear section is pivotably mounted to the fuselage for movement between a lowered, forward position when the landing gear is in the first operating position and a raised, rearward position when the landing gear is in the second operating position.

5. The aircraft of claim 3 wherein the front section of the landing gear is axially extendible between a lowered position when the landing gear is in the first operating position and a raised position when the landing gear is in the second operating position.

6. An aircraft that can be converted between a road configuration and a flight configuration, comprising a fuselage a pair of wings and landing gear, wherein the wings are movable between an operative position when the aircraft is in the flight configuration, in which the wings extend outwardly from the fuselage, and an inoperative position when the aircraft is in the road configuration, in which the wings are in a folded position and at least a portion of each wing is located above the fuselage, and wherein the landing gear is movable between at least two different operative positions, wherein in a first operating position of the landing gear when the aircraft is in the flight configuration the center of gravity of the aircraft is in a first relatively rearward and elevated position, and in a second operating position of the landing gear when the aircraft is in the road configuration the center of gravity of the aircraft is in a second relatively forward and lowered position.
